(19) United States
(12) Patent Application Publication
(10) Pub. No.: US 2026/0138518 A1
(43) Pub. Date: May 21, 2026

(54) SOLAR TABLE TRANSPORT AND AUTOMATED LANDING

(71) Applicant: Terabase Energy, Inc., Berkeley, CA (US)

(72) Inventors: James Christopher Deacon, Dallas, TX (US); Erik Robert Cummins, Davis, CA (US); Matthew Paul Campbell, Berkeley, CA (US); Adam Hansel, Davis, CA (US); Tyler Grushkowitz, Corvallis, OR (US); Soren Jensen, Corte Madera, CA (US)

(73) Assignee: Terabase Energy, Inc., Berkeley, CA (US)

(21) Appl. No.: 19/441,301

(22) Filed: Jan. 6, 2026

Related U.S. Application Data
(63) Continuation-in-part of application No. 18/616,152, filed on Mar. 25, 2024, now Pat. No. 12,539,801.
Application No. 18/616,152 is a continuation of application No. 17/464,178, filed on Sep. 1, 2021, now Pat. No. 11,999,284.

(51) Int. Cl. B60P 3/00; F24S 25/30; F24S 25/65; H02S 99/00

(52) U.S. Cl. CPC B60P 3/00; F24S 25/30; F24S 25/65; H02S 99/00

(57) ABSTRACT

A solar table mobile transport is described that moves a solar table to a point of installation. The solar table mobile transport comprises multiple motors that allow movement within a three-dimensional coordinate system as well as provide angular controls of pitch, yaw, and roll. These motors enable at least one alignment process used to install the solar table to a mounting structure within a solar system. A parking tolerance zone is first determined using ambient images, infrastructure information, and parameters of the mobile transport. Afterwards, the mobile transport implements horizontal alignment, vertical alignment, and insertion process for autonomous solar table landing.

### CROSS REFERENCE TO RELATED PATENT APPLICATIONS

This application is a continuation-in-part of U.S. patent application Ser. No. 18/616,152 (Docket No. 20179-2504USC), filed on Mar. 25, 2024, entitled “SOLAR TABLE MOBILE TRANSPORT”, and listing Matthew Campbell, Brian Coleman, Tianya Zhao, Adam Hansel and Soren Jensen as inventors, which is a continuation of U.S. Patent Application No.17/464,178 (Docket No. 20179-2504US), filed on Sep. 1, 2021, entitled “SOLAR TABLE MOBILE TRANSPORT”, and listing Matthew Campbell, Brian Coleman, Tianya Zhao, Adam Hansel and Soren Jensen as inventors. The aforementioned patent documents are incorporated by reference herein in their entirety.

### TECHNICAL FIELD

The present disclosure relates generally to a motorized solar table transport used in the construction of large-scale solar systems. More particularly, the present disclosure relates to a motorized solar table transport that moves a solar table from a solar table assembly factory to an installation point and provides alignment capabilities across a three-dimensional coordinate system and angular controls of pitch, yaw and roll to enable autonomous solar table landing.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is cost-effective management of the construction process and the ability to efficiently move components around the site during the construction process.

Large-scale solar panel systems typically include thousands of solar panels that are located across a multi-acre terrain and that are electrically coupled to provide a source of energy. These large-scale systems are oftentimes located in remote areas and require a significant investment in materials, resources and labor in their installation and design. The sourcing and delivery of materials and resources for these installations can be problematic and inconsistent. A further complication is the reliable and safe movement of these materials and resources across large areas of the construction site as well as maintaining consistent installation processes at each point of installation within the site. These issues further contribute to an increase in the cost and complexity of what is already a very cost-sensitive process.

FIG. 1 illustrates a typical prior-art installation process for solar systems. This prior-art installation process is implemented such that all mounting equipment for each solar panel is individually assembled and installed at its location within the larger system. The cost-effectiveness of this approach works fine within smaller solar deployments but struggles to cost-effectively scale to large solar systems as described below.

This traditional deployment 101 relies on materials being delivered to a deployment site via an access road. The materials are then processed and staged at the deployment site by a crew. A small portion of this delivered material is then moved by heavy equipment to a specific location where a solar panel and mounting equipment are assembled and installed at that location 102. The step is then repeated for an adjacent location 103 where materials are subsequently delivered, assembled, and installed for a neighboring solar table within the system. While this approach may be effectively deployed in the installation of smaller solar systems, it becomes cost-prohibitive and labor-intensive as the size of the system increases.

What is needed are systems, devices and methods that reduce complexity, labor demanding, and cost requirement of the installation of large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. (“FIG.”) 1 shows a prior art assembly and installation process of large-scale solar panel systems.

FIG. 2 is a diagram showing a centralized assembly and installation of a solar system including mobile transport of solar tables in accordance with various embodiments of the invention.

FIG. 3 is an exemplary sequence of diagrams illustrating an installation of a solar table within a solar system using a mobile transport according to various embodiments of the invention.

FIG. 4 is an overhead view of a solar table mobile transport according to various embodiments of the invention.

FIG. 5 is a side-view of a solar table mobile transport in a lower position in accordance with various embodiments of the present invention.

FIG. 6 is a side-view of a solar table mobile transport in a raised position in accordance with various embodiments of the present invention.

FIG. 7 is a front view and a back view of a solar table mobile transport according to various embodiments of the invention.

FIG. 8 is a focused front view of a solar table mobile transport illustrating rotational functionalities according to various embodiments of the invention.

FIG. 9 is a schematic view of a solar table mobile transport in a parking position for solar table landing in accordance with various embodiments of the present invention.

FIG. 10 is a process to determine a parking tolerance zone for solar table landing in accordance with various embodiments of the present invention.

FIG. 11 is a first positioning tag attached to a previously installed solar table in accordance with various embodiments of the present invention.

FIG. 12 is a second positioning tag attached to a pile for solar table landing in accordance with various embodiments of the present invention.

FIG. 13 is a process for automatic solar table landing in accordance with various embodiments of the present invention.

FIG. 14 is an illustration showing the different systems on which various embodiments of the invention may function.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of the solar table mobile transport.

Furthermore, connectivity between components or systems within the figures is not intended to be limited to direct connections. Rather, data between these components may be modified, re-formatted, or otherwise changed by intermediary components. Also, components may be integrated together or be discrete prior to construction of a solar panel mobile transport.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently across different solar table mobile transports; and (4) certain functions may be performed concurrently or in sequence.

Furthermore, it shall be noted that many embodiments described herein are given in the context of the assembly and installation of large numbers of solar tables within a system, but one skilled in the art shall recognize that the teachings of the present disclosure may apply to other large and complex construction sites in which resources and personnel are difficult to manage and accurately predict. Additionally, embodiments of a solar table mobile transport may be implemented in smaller construction sites.

In this document, “large-scale solar system” refers to a solar system having one thousand or more solar panels. The word “resources” refers to material, parts, components, equipment, or any other items used to construct a solar table and/or solar system. The word “personnel” refers to any laborer, worker, designer, or individual employed to construct or install a solar table or solar system. The term “solar table” refers to a structural assembly comprising a torque tube and/or purlins with module rails. Some types of solar tables may have supplemental structure that allows them to connect to foundations/piles while other types do not have this supplemental structure. A solar table may have (but is not required) solar panels and/or electrical harnesses. The term “solar table mobile transport” (hereinafter, “mobile transport”) describes a vehicle used to move a solar table to an installation site and facilitate an installation process of the solar table. A mobile transport may be driven by personnel, controlled by remote control or move autonomously within at least a portion of a solar system construction site. The term “motor” is defined as a structural device that produces motion of a solar table, this motion may be unidirectional or multidirectional. Examples of some motors may include elements such as actuators, tracks, etc. that help in producing motion of the solar table.

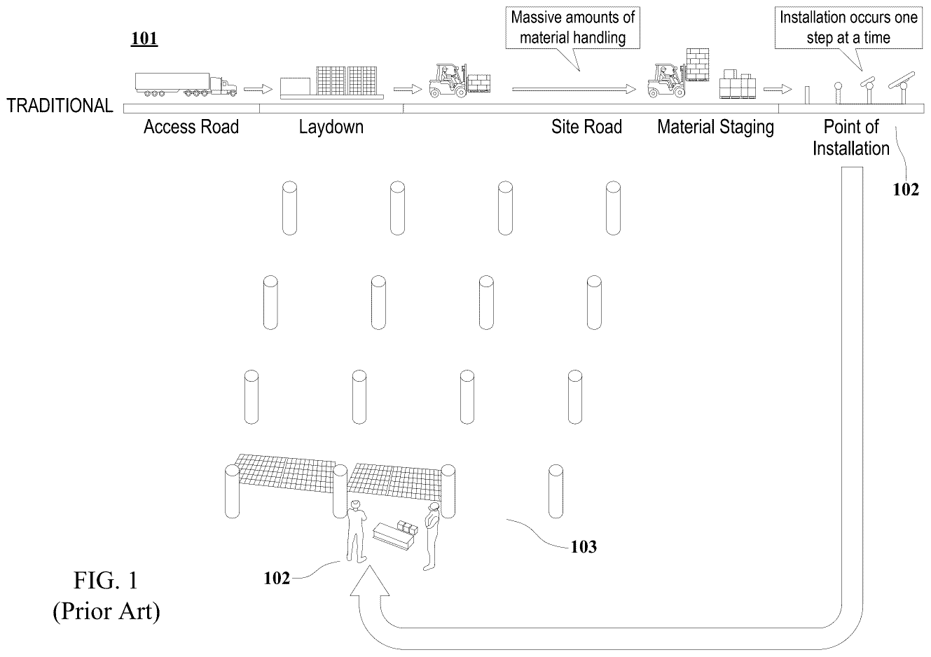

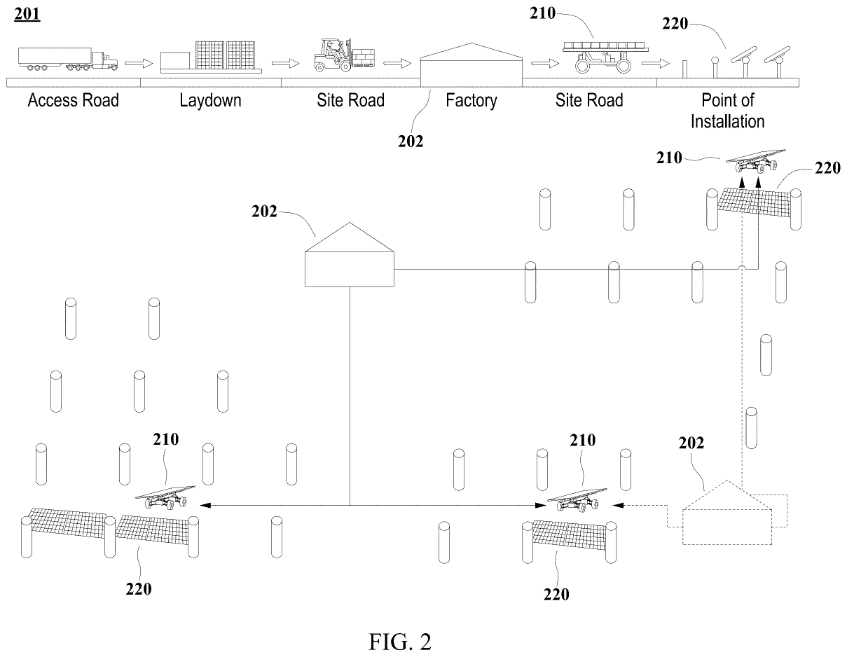

FIG. 2 provides an overview of a centralized solar table assembly and installation for large-scale solar systems according to various embodiments of the invention. Embodiments of the invention transition the prior art approach of assembly and installation at single location sites to a centralized and coordinated assembly factory that allows a more cost-effective and dynamic process of constructing large-scale solar systems. This centralized assembly of solar system components, such as solar tables, necessitates a more robust transport vehicle to move the pre-assembled components to the installation site. Additionally, the installation of these pre-assembled components may require functionality to support the alignment and integration of these components into the system.

Resources are brought to a construction site 201 for a large-scale solar system and initially processed. These resources are delivered to one or more assembly factories 202 where a coordinated and centralized solar table assembly process is performed. In certain embodiments, a construction site may have multiple centralized factories 202. As shown in FIG. 2, there are two centralized factories 202 strategically located at the site. The location and number of centralized factories 202 may depend on several parameters including the size of the site, the terrain of the site, the design of the site and other variables that relate to the construction of the large-scale solar system.

Assembled solar tables and equipment are moved from a factory 202 to a point of installation 220 via motorized vehicles 210 such as a mobile transport. In certain embodiments, the mobile transports are specifically designed to transport solar tables along a site road to the point of installation 220. As previously mentioned, the mobile transport 210 may be driven by personnel, may be controlled by remote control or autonomously driven by a computer system. The time and/or sequence in which solar tables are delivered to points of installation 220 may depend on a variety of factors that may be analyzed to configure a preferred schedule.

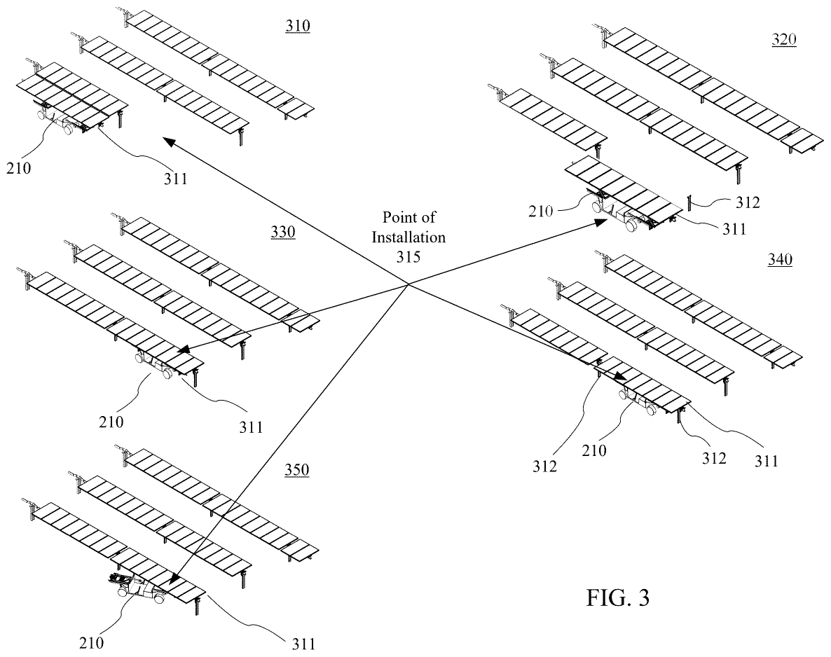

FIG. 3 illustrates a sequence of installation steps of a solar table at an installation site using a solar panel mobile transport according to various embodiments of the invention. As shown in 310, a mobile transport 210 supporting a solar table 311 approaches a point of installation 315. The solar table 311 is secured to the mobile transport 210 by a solar table attachment component that securely holds the solar table above the mobile transport 210. In certain embodiments, the solar table 311 is assembled and secured to the attachment component at a centralized assembly factory and subsequently driven to the point of installation 315.

As shown in 320, the mobile transport 210 approaches the point of installation 315 in preparation for installation within the solar system. The point of installation 315 comprises structures 312 used to secure the solar table within the system. For example, a solar table 311 may be secured to a previously installed table whereby a torque tube in the solar table 311 is inserted into a previously installed table. The previously installed table may be secured to a pile 312 where threaded fasteners/rivets connect its bearing housing assembly/brackets to the pile 312. The mobile transport 210 may be capable of side-shifting the solar table, thus it doesn't have to park between the piles to land the table. Instead, the mobile transport may park in a parking tolerance zone that is partially in-between the piles to enhance the range of reach of the side-shift. As shown in 330, the mobile transport 210 aligns the solar table 311 at the installation point 315 for subsequent integration into solar system. This alignment process will be discussed in more detail below and includes alignment along a three-dimensional coordinate system as well as angular control of yaw, pitch, and roll.

As shown in 340, the solar table is secured within the solar system after alignment is completed. This securitization process includes attached the solar table 210 to piles 312 that lock the solar table in line with adjacent solar tables. One skilled in the art will recognize that other processes may be employed to securely lock a solar table 311 within the system and may use other components that replace or supplement the piles 312.

As shown in 350, the mobile transport 210 detaches from the solar table 311. The attachment component lowers after the solar table 311 is secured within the system so that the mobile transport 210 may leave the point of installation 315.

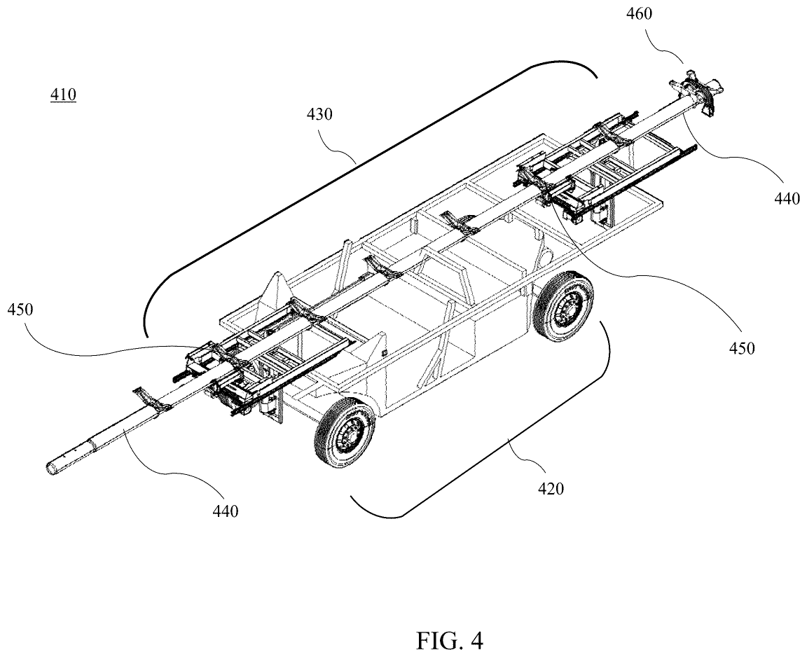

FIG. 4 illustrates a mobile transport in accordance with various embodiments of the invention. This mobile transport 410 comprises an attachment component 430 and a transport component 420 that supports a robust vehicle that can securely move solar tables to an installation point and support alignment and integration of the table into the solar system. In this example, the attachment component 430 is coupled to a torque tube 440.

The transport component 420 comprises a vehicular segment that can move throughout a solar system construction site under the control of a driving system. As previously discussed, the transport component may be controlled by an in-vehicle driver, a remote control being used by personnel or an autonomous driving system. If an autonomous driving system is employed, the transport component 420 comprises autonomous driving capabilities which include both a vehicle location element (such as a GPS location, autonomous sensor and image processing, and/or virtual construction site map including roads between factories and installation sites). The transport component 420 also comprises a vehicular segment such as a wheel system, tractor system and/or robotic movement system that moves a solar table from a factory to an installation point. One skilled in the art will recognize that the transport component 420 may be modified and/or supplemented with a variety of structural and functional elements to further assist in the transportation of solar tables within a solar system construction site.

The attachment component 430 may be located above and coupled to the transport component 420. The attachment component 430 may also be an extension to transport component 420 at a variety of angles and across one or more portions of the attachment 430. The attachment component 430 comprises a plurality of attaching elements that securely attach to a solar table. In one example, the attaching elements are end effectors 450 that securely hold a torque tube 440 to allow movement and alignment processes. The attachment component 430 also includes independent motors that position and align a solar table within a three-dimensional space as well as control angular movement to facilitate proper integration into a system. As will be described in more detail below, these motors can provide alignment of heavy structures, such as solar tables, using personnel controlling the motors or autonomous control where alignment movement is driven by sensors.

The end effectors 450 may be positioned anywhere on the attachment component 430 to securely hold a variety of different shapes and types of solar tables. In one embodiment, the end effectors 450 are positioned along an axis to allow secure attachment to a torque tube 440 of a solar table. This torque tube 440 may have other components, such as solar panels, attached to it.

One skilled in the art will recognize that the attachment component 430 may be modified and/or supplemented with a variety of structural and function elements to further assist in the attachment process to a solar table or the alignment/installation process of the solar table within the solar system.

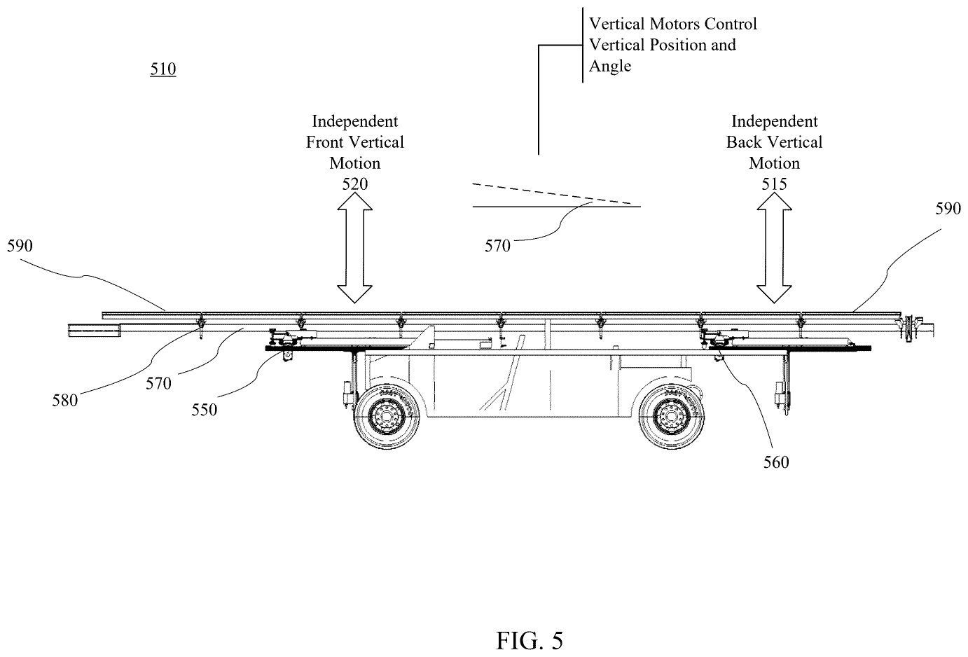

FIG. 5 illustrates a side-view of a mobile transport with an attachment component in a lowered position in accordance with various embodiments of the invention. This figure shows a first motor 550 near the front section of the mobile transport 510 and a second motor 560 near the back end of the mobile transport 510. In certain embodiments of the invention, each of these motors provides independent vertical motion for raising and lowering an attached solar table. In particular, the first motor 550 provides independent first vertical motion 520 and the second motor 560 provides second vertical motion 515 of the solar table as well as providing pitch angle 570 of the solar table. This vertical motion and pitch control is a component in alignment processes supported by the mobile transport 510.

In this embodiment, an attachment component of the mobile transport 510 includes end effectors 580 that couple the attachment component to a torque tube 570 of the solar table. Additionally, the solar table comprises at least one solar panel 590.

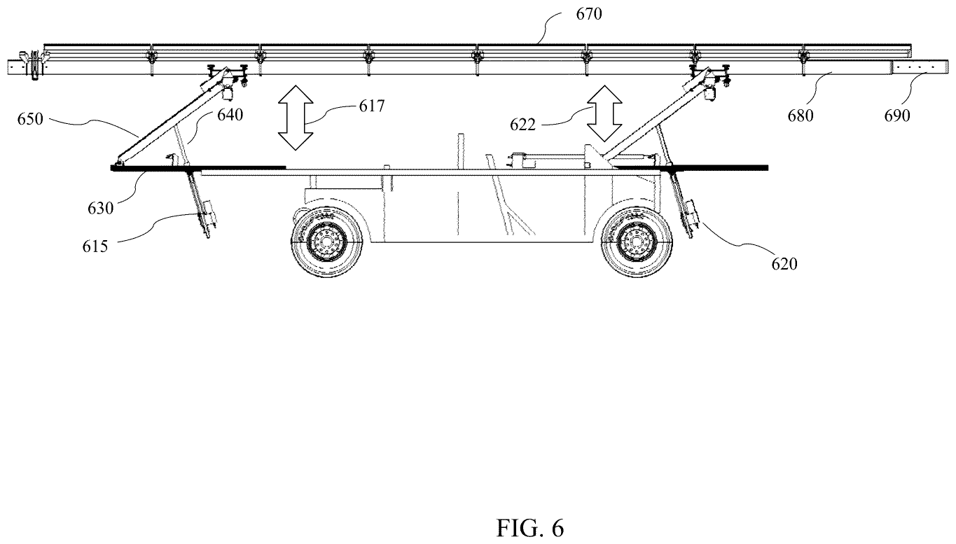

One skilled in the art will recognize that various types of motors may be deployed within the mobile transport 510 to provide vertical motion and pitch control. In certain embodiments, pitch control is realized by having a variation of lift applied to the solar table between the first motor 550 and the second motor 560. The motors used to generate vertical lift and control pitch of the solar table may have a variety of structures and functions according to the requirements of the installation processes, an example of which is illustrated in FIG. 6.

FIG. 6 illustrates a side-view of a mobile transport with an attachment component in a raised position in accordance with various embodiments of the invention. In this example, the first motor 620 provides a lift magnitude 622 and the second motor 615 provides a lift magnitude 617 that are equal resulting in zero pitch. If these two lift magnitudes were different, a corresponding pitch angle is generated across the solar table.

FIG. 6 also illustrates an exemplary motor system for providing vertical lift that includes a motor 615, a horizontal support 630, a vertical support 650 and an actuator arm 640. The motor 615 extends or retracts the upper end of the actuator arm 640 that results in a vertical movement of the vertical support 650. This independent motorized movement on both motors 615 and 620 allows robust vertical and pitch control of the solar table relative to a method of installation at an installation point.

In one example, the solar table is installed within a system by inserting an end of a torque tube 680 of a solar table 670 into an opening of mounting rail or another torque tube. As shown, the torque tube 680 comprises a swaged end 690 that has a smaller circumference than the center of the torque tube. This swaged end 690 is inserted into the opening to secure it to a mounting rail, neighboring solar table, or other structure within the system. The swaged end 690 may also have drilled holes that provide locking fasteners to be inserted that further secure the torque tube 680 to the structure to which it is coupled.

One skilled in the art will recognize that proper alignment of the swaged end 690 to an opening within bearing housing assembly 460 or adjacent structure will also require horizontal and angular yaw control of the solar table as well as rotational control to align drilled holes in the swaged end 690 and mounting structure.

Although a torque tube with a swaged end is shown in FIG. 6 for tubing coupling, one skilled in the art shall understand that a torque tube may not have a swaged end and various configurations may also be used for tube coupling. For example, a tube coupler may be used to clamp two torque tube ends together. The mobile transport may align the torque tube 680 to a previoouly installed torque tube. Afterwards, a tube coupler is then installed to securely clamp the two tubes together.

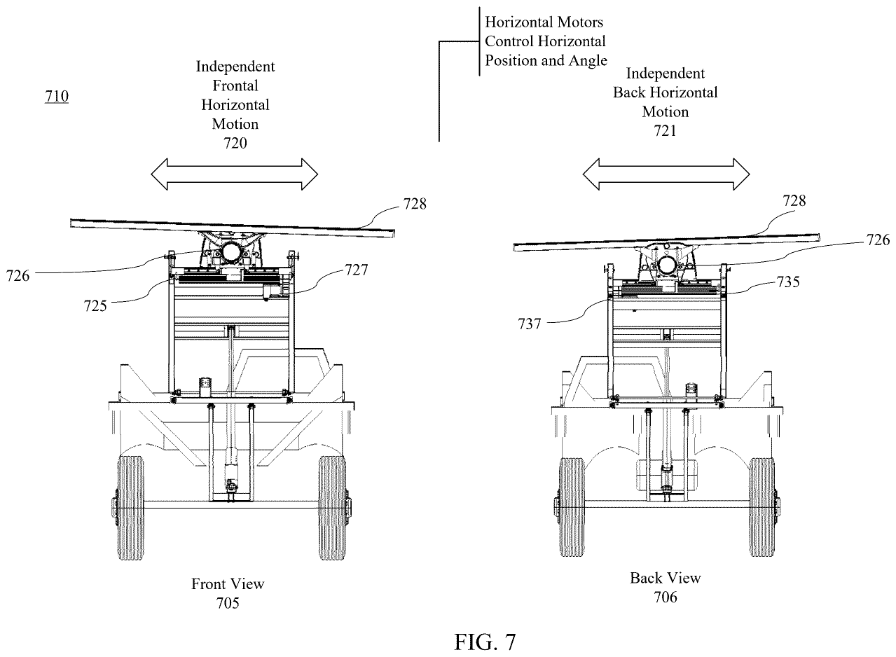

FIG. 7 illustrates a mobile transport 710 that comprises two independent motors that provide horizontal movement and yaw control of a solar table according to various embodiments of the invention. In this Figure, a front view 705 and a back view 706 illustrate the front view showing a first horizontal motor 727 and a back view showing a second horizontal motor 737.

The first horizontal motor 727 provides independent horizontal control 720 of a front portion of a solar table having a torque tube 726 and at least one solar panel 728. In this example, the first horizontal motor 727 causes a first set of horizontal tracks 725 to move the front portion of the solar table along a horizontal plane. The horizontal tracks include an upper track and a lower track that move the solar table accordingly. A second horizontal motor 737 cases a second set of horizontal tracks 735 to move the back portion of the solar table along the horizontal plane. The independent horizontal movement 720, 721 allows a robust horizontal movement of the solar table as well as yaw angular control. In certain embodiments, this horizontal movement and yaw angular control enhances alignment processes supported by the mobile transport including the insertion of a swaged end 690 of the torque tube 726 into an opening of an adjacent table torque tube or other structure.

One skilled in the art will recognize that various types of motors may be deployed within the mobile transport 710 to provide horizontal motion and yaw control. In certain embodiments, yaw control is realized by having a variation of horizontal movement applied to the solar table between the first motor 727 and the second motor 737. The motors used to generate horizontal lift and control yaw of the solar table may have a variety of structures and functions according to the requirements of the installation processes,

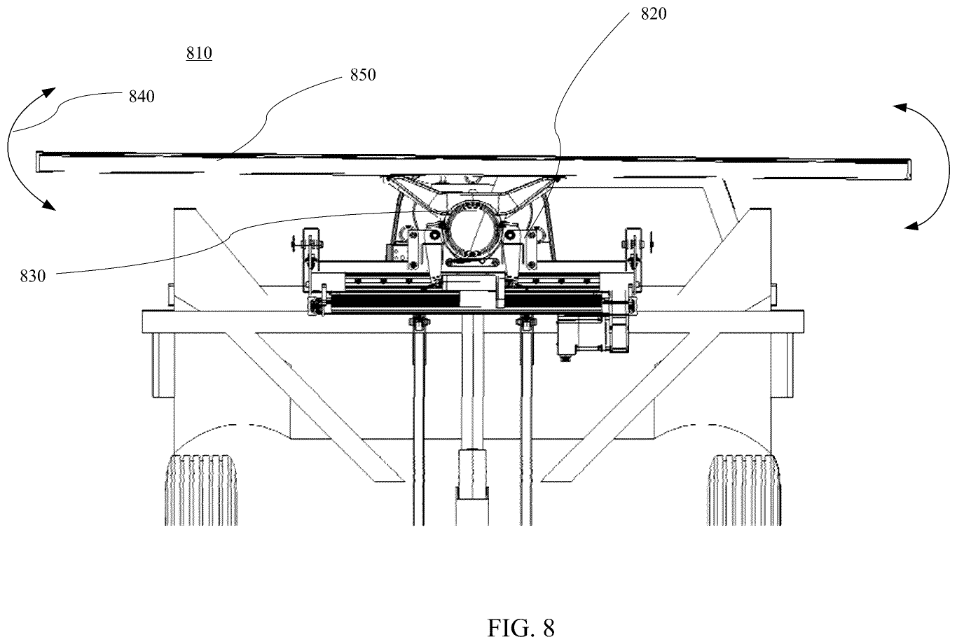

Embodiments of the invention also include a mobile transport having a rotating actuator that rotates a solar table. As shown in FIG. 8, a mobile transport 810 is provided with a rotational actuator 820 that rotates a solar table around an axis. In this example, a solar table having a torque tube 830 and at least one solar panel 850 can be rotated around a center point of the torque tube 830. This rotational movement allows further functionality in the alignment process.

In one embodiment, the rotational movement allows a swaged end 690 having multiple drill holes to be rotated within an opening of a pile or other structure. This rotational movement allows the drill holes within the swaged end 690 to be aligned to corresponding holes in the mounting structure. Thereafter, threaded fasteners or rivets may be placed within the set of drill holes to secure the swaged end 690 in opening structure.

One skilled in the art will recognize that a solar table may have a variety of different support structures such as beams, purlins, etc., that either supplement or replace a torque tube. All these different solar type examples are intended to fall within the scope of certain embodiments of the invention.

One skilled in the art will recognize that the different movements supported by the mobile transport support robust alignment processes that allow for a more efficient and accurate alignment of a solar table to a corresponding mounting structure. In some embodiments, the alignment process(es) may be performed manually by personnel at the installation site that controls each of the motors during alignment. In other embodiments, the alignment process(es) may be automatically performed by sensors and motor controls such that motor movement is controlled by computerized analysis of sensor data and/or image data. A variety of sensor technologies may be employed by a mobile transport such as LiDAR, camera sensors (including stereo cameras), radar sensors, and other sensor technologies known to one of skill in the art. Furthermore, active and passive sensor systems may also be deployed.

In certain examples, detachable sensor systems may be positioned on a solar table (such as on a torque tube) prior to or during installation of the solar table. The detachable sensor device/system may be removed from the solar table once installation is complete and positioned on another table that needs to be installed within the system.

In other examples, the alignment process may comprise both manual and automated processes that result in the installation of a solar panel within the system.

The mobile transport may also include verification devices that confirm a solar table has been properly installed. These verification devices may include sensors, e.g., magnetic and microware proximity sensors, that measure movement under a test force of the solar table to determine whether a swaged end 690 is tightly inserted within a corresponding mounting structure.

Landing a solar table onto two piles precisely may present significant alignment challenges. The landing process requires inserting one end of the torque tube of the solar table (as referred to as a landing solar table hereinafter) into a torque tube of a previously installed solar table, securing the connection of the torque tubes in place, and then lowering the opposite end of the landing solar table into a jack mounted on the rear pile or straight onto the rear pile/bearing. Currently, this is achieved by transporting the landing solar table on a rover (also referred to as a lander or a lander vehicle), which drives it approximately to an installation position. An operator uses a multi-axis (e.g., five-axis) joystick control to manually align a torque tube of the landing solar table to a previously installed solar table, insert one end of the torque tube to a correct depth, and subsequently lower the opposite end of the torque tube into the jack. Such a manual operation approach is slow and labor-intensive, as manually aligning a large, heavy structure with such precision is difficult. Even small errors in alignment may require the operator to retract, re-align, and repeat the process, further adding significant time and reducing overall efficiency.

Autonomous table landing can greatly improve the efficiency of this landing process. In one or more embodiments, after the landing solar table is driven to or in proximity to an installation spot, the mobile transport or a lander vehicle may perform, enabled by the operator holding a deadband button, all required alignment and landing steps at or near maximum speeds of the motors. In addition to faster landing operation, the autonomous table alignment and landing process requires significantly less operator training. The system may further be configured to detect whether a solar table landing operation is feasible for a parking position, and if not, make recommendations for parking position changes and/or send an alert message to an on-site manager for attention and intervene. Furthermore, an alert message may also be triggered when the autonomous system has a failure to complete a process or is unable to determine or move the vehicle to an acceptable parking tolerance zone. The notification to manager/operator can be as simple as an audible tone and/or visible warning light. Once the landing process is completed, a feedback may be transmitted to the operator or manager. In a fully autonomous system, an operator/manager may be assigned to supervise multiple transports or workfronts to resolve unexpected situations and other issues that the autonomy systems of the mobile transports can't resolve on their own. In some embodiments, the park assist system may be configured to provide feedback to the operator during the parking approach through audio or visible signals, e.g., an audible tone with changing frequency, a flashing visible light emitted from a light tower, or an image-based system shown on a tablet placed in vehicle.

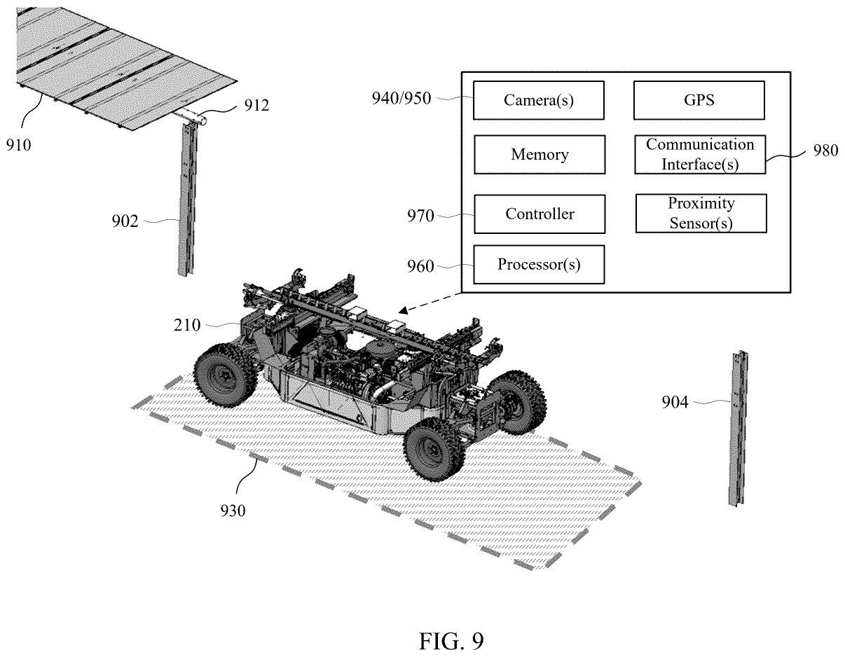

FIG. 9 depicts a schematic view of a solar table mobile transport in a parking position for solar table landing in accordance with various embodiments of the present invention. When the mobile transport 210 carries a landing solar table 670 (not shown in FIG. 9) to a point of installation, the mobile transport 210 needs to be within a parking tolerance zone 930 to allow maneuverability of the solar table within adjustment limits of the table positioning system for successful solar table landing. The mobile transport 210 may comprise one or more cameras or 3D scanners to capture ambient images, a global positioning system (GPS) sensor for mobile transport positioning, a communication interface to enable wireless communication for remote control, control software update, etc., one or more proximity sensors deployed around the mobile transport to detect objects nearby for vehicle maneuver safety at the point of installation, a controller to position and align the solar table within a three-dimensional space as well as control angular movement to facilitate manual/automatic solar table landing, a memory to store non-volatile instructions executable by the controller.

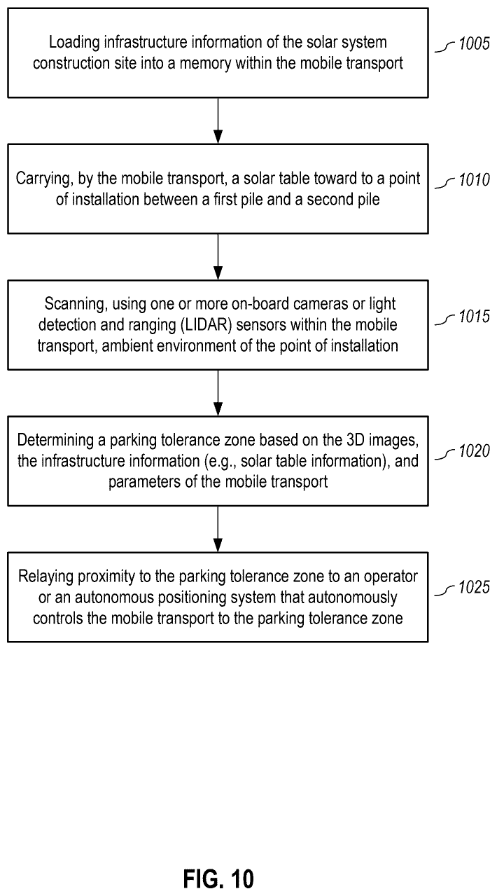

The parking tolerance zone 930 may be dynamically determined based on one or more parameters. FIG. 10 is a process to determine such a parking tolerance zone for solar table landing in accordance with various embodiments of the present invention. In step 1005, infrastructure information of the solar system construction site is loaded into the memory within the mobile transport. The infrastructure information may comprise information of installed piles, e.g., pile numbers, inter-pile gap, pile height, pile orientation, GPS location for each pile, etc., and solar table parameters, e.g., size, weight, torque tube specifications, torque end configuration, designed torque tube coupling depth for inter-tube connection, etc.

In step 1010, the mobile transport carries a solar table toward to a point of installation between a first pile 902 and a second pile 904. The point of installation may be assigned to the mobile transport automatically based on solar table landing tasks to be performed by the mobile transport. The mobile transport may be driven autonomously based on infrastructure information of the solar system construction site. Since the solar system site is under construction, driving routes within the construction site need to be planned according to the infrastructure information.

In step 1015, the mobile transport scans, using one or more on-board cameras or light detection and ranging (LIDAR) sensors, ambient environment of the point of installation. The cameras may comprise a stereo camera that uses two or more lenses with separate image sensors to perceive depth and generate three-dimensional (3D) images for the ambient environment. The 3D images may comprise ground situation (flatness, slope, obstacles, etc.) in between the first pile 902 and the second pile 904, and information of the piles (height, distance, orientation, etc.).

In step 1020, a parking tolerance zone is determined based on the 3D images, the infrastructure information (e.g., solar table information), and parameters of the mobile transport, which may comprise weight of the mobile transport, adjustment limits for horizonal, vertical, and side-shift movements and yaw/pitch/roll angle controls. For example, mobile transport limits and weight of the solar table need to be taken into consideration when determining the parking tolerance zone for side-shift operation. A mobile transport would have much less side-shift range with a heavyweight solar table load compared to with a lightweight solar table. In another example, the determination of the parking tolerance zone should take into consideration of the size of the solar table and the inter-pile gap to ensure that the mobile transport can move the solar table adequately for coupling to a previously installed solar table. Parking within the parking tolerance zone enables the mobile transport to safely perform subsequent automatic solar table landing operations.

In step 1025, proximity to the parking tolerance zone may be relayed to an operator by audible or visible feedback, or to an autonomous positioning system that autonomously controls the mobile transport to the parking tolerance zone. In a semi-autonomous or supervised autonomous system, an operator may supervise the mobile transport as the vehicle moves into position into the parking tolerance zone and may interfere via one or more safety systems if an unsafe situation occurs or if the autonomous system fails to position the vehicle correctly. Safety systems may include a dead man's switch (or button), traditional emergency stop (E-stop), or other means of intervention. In some embodiments, the parking target zone is determined as a landing vehicle is approaching and a viable path to the target zone is relayed to the operator. For the autonomy case the path to the parking zone is used to guide the vehicle on the viable path to the parking zone as it is approaching.

It shall be noted that the determination of the parking tolerance zone may be performed locally using the on-board processor 960 on the mobile transport. Alternatively, the mobile transport may transmit scanned 3D images via a communication interface 980 (e.g., a Wi-Fi or cellular communication interface) to a cloud for cloud computing or to an edge device for edge computing to determine the parking tolerance zone and transmit the determined result back to the mobile transport. In case a parking tolerance zone cannot be determined due to terrain restrictions (e.g., obstacles, existence of debris materials, etc.) or incorrectly installed piles, the mobile transport, the cloud, or the edge device may send an alert message to an on-site manager for attention and intervene.

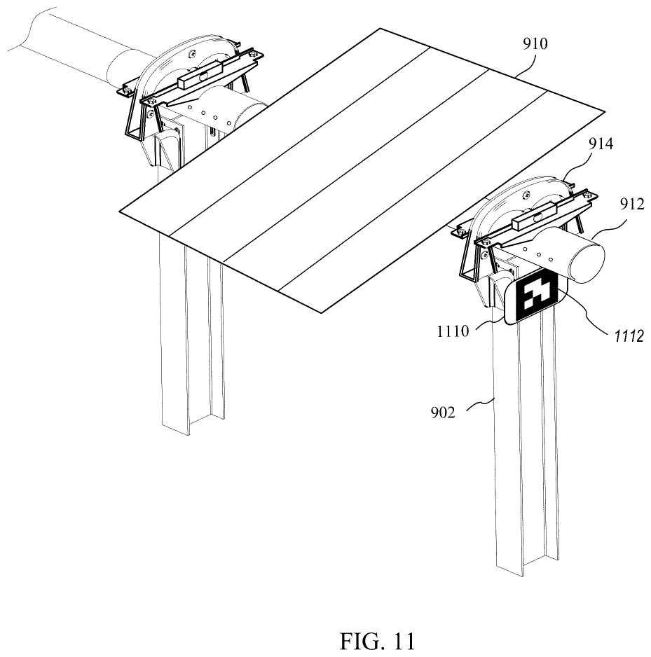

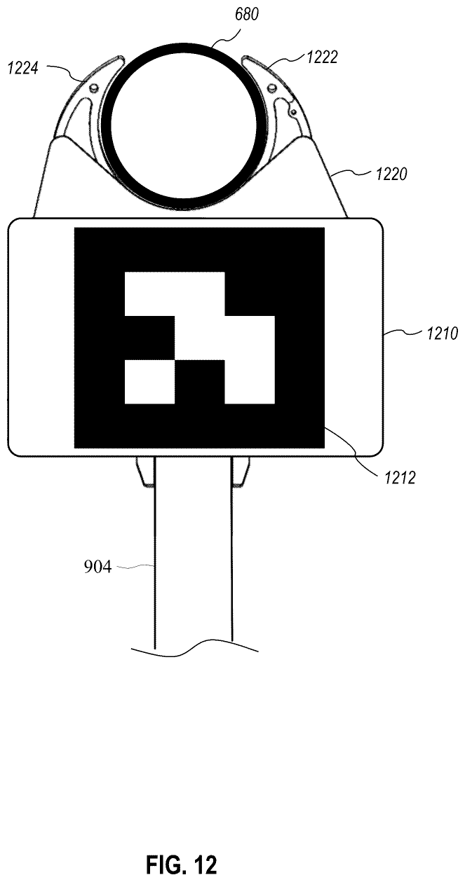

In one or more embodiments, positioning tags may be used to facilitate automatic solar table landing. FIG. 11 and FIG. 12 depict respectively a first positioning tag attached to a previously installed solar table and a second positioning tag attached to a pile for solar table landing in accordance with various embodiments of the present invention. The first positioning tag 1110 and the second positioning tag 1210 are both visual fiducial markers, e.g., April tags, for high-accuracy localization.

Each positioning tag is high-contrast marker that comprises a boarder surrounding a binary grid pattern, e.g., a first grid pattern 1112 and a second grid pattern 1112. The binary grid patterns are generally black and white pixels for high-contrast and therefore, are robust to changing lighting conditions and partial occlusions and make the tags easier for detection. A unique identification (ID) is encoded in each binary pattern to differentiate from each other.

The first positioning tag 1110 may be mounted to the first pile 902 directly or on a first jig attached to a torque tube 912 of the previously installed solar table 910, which is securely supported onto the first pile via a bracket housing assembly 914. The first grid pattern 1112 may be encoded to comprise information of the first pile 902, information of the previously installed solar table 910, information of the landing solar table 670, a designated coupling depth between the landing solar table 670 and the previously installed solar table 910, etc. Similarly, the second positioning tag 1210 may be mounted on the second pile 904 directly or on a second jig 1220 installed on the second pile 1220. The second grid pattern 1212 may be encoded to comprise information of the second pile 904, mounting parameters (vertical or horizontal positions) for the torque tube of the landing solar table onto the second pile 904. The second jig 1220 comprises a jig base 1220 that can be pre-shifted vertically and horizontally to meet requirements of the mounting parameters. A pair of claws 1222/1224 are coupled to the jig base 1220 and may be controlled to be opened or closed to receive or lock a torque tube of the landing solar table. When the torque tube 680 of the landing solar table 670 is landed between the claws 1222/1224, the landing solar table 670 is guaranteed to be aligned correctly.

The mobile transport comprises a first camera and a second stereo camera 940/950, each having two or more lenses with a separate image sensor for each lens. The stereo cameras give the mobile transport the ability to capture three-dimensional (3D) images for stereo view and range imaging. The first stereo camera 940 may be mounted in the front of the mobile transport and the second stereo camera 950 may be mounted at the back of the mobile transport.

In one or more embodiments, the stereo cameras 940/950 may be mounted on the first set of horizontal tracks 725 and the second set of horizontal tracks 735 (eye on hand camera as shown in FIG. 7) respectively. The embodiment with the camera mounted on the end effector provides a direct view of the target from the end effector and needs calculating only the relative position of the target in relation to the camera, thus eliminating the challenge of calculating both the position of the end effector and the target. In this configuration, the stereo cameras 940/950 may move with the solar table when the solar table is lifted vertically or shifted sideward or horizontally. This provides a closed loop to handle unexpected conditions, e.g., when the mobile transport is partially in a ditch and is skewed. Stereo cameras 940/950 send captured frames to a processor 960, which may be an image or graphic processing processor running a tag detection algorithm to determine positions of the positioning tags 1110/1210. The positions may then be sent to a controller 970, which may be a programmable logic controller (PLC) configured to control one or more actuators for desired movements.

The controller 970 may identify a position of the positioning tags 1110/1210 with reference to stereo cameras 940/950 at a timestamp of each frame taken by the stereo cameras 940/950. From the identified positions of the tags, an alignment vector is calculated to align the torque tube of the landing solar table. The target actuator positions may then be calculated with inverse kinematics.

It shall be understood that although the positioning tags 1110/1210 are shown in FIG. 11 and FIG. 12, the controller 970 may use 3D images of the previously installed solar table and piles for autonomous solar table landing without any fiducials. For example, the autonomous system may be configured or trained to detect the previously installed tube, the piles 902/904, the jack 1220, which have visual features for detection and autonomous solar table landing guidance. Such configurations shall also be within the scope of the present disclosure.

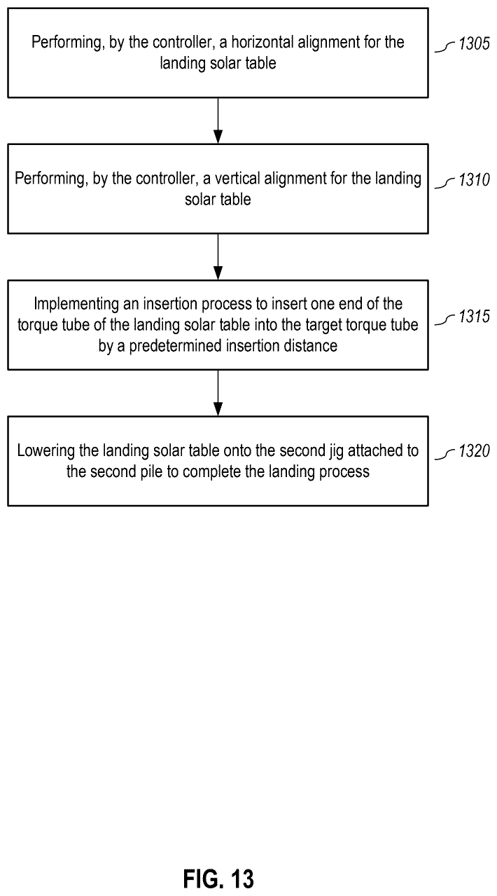

Autonomous solar table landing may start once the mobile transport is parked within a parking tolerance zone. Such a landing operation may be a multi-stage process. In each stage, the controller computes one or more actuator positions for each of multiple degrees of freedom. FIG. 13 depicts a process for automatic solar table landing in accordance with various embodiments of the present invention. In step 1305, the controller first performs a horizontal alignment. It may lift the landing solar table in a height above the first pile 902 and the second pile 904 for collision prevention and activate one or more actuators for horizonal alignment, which may involve side shift, yaw angle adjustment, roll angle adjustment, pitch angle adjustment, and/or forward/backward movement for the landing solar table such that the torque tube of the landing solar table is longitudinally in parallel to the target torque tube. The landing solar table may be positioned at a predetermined distance, e.g., a few inches, in front of a torque tube (also referred to as a target torque tube) of a previously installed solar table once the horizontal alignment is completed.

In step 1310, the controller then implements a vertical alignment to lower the torque tube of the landing solar table into an insertion axis, which is also the longitudinal axis of the target torque tube. A safe distance above the rear pile may be maintained during the vertical alignment to avoid collisions. In step 1315, once the vertical alignment is completed, the controller implements an insertion process to insert one end (swaged end 690) of the torque tube of the landing solar table into the target torque tube by a predetermined insertion distance, e.g., a length of a swaged end 690 as shown in FIG. 6, for subsequent secure connection between the torque tube of the landing solar table and the target torque tube. In step 1320, the landing solar table is lowered onto the second jig 1220 attached to the second pile 904 (or directly to the pile) to complete the landing process and to allow the mobile transport to drive away for subsequent solar table carrying/landing tasks.

Aspects of the present patent document are directed to information handling and processing systems on which the analyzers, generators, process steps, and other elements may operate. For purposes of this disclosure, an information handling and processing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output devices, such as a speaker, a microphone, a camera, a keyboard, a mouse, touchscreen, and/or a video display. The information handling system may also include one or more buses operable to transmit communications between the various hardware components.

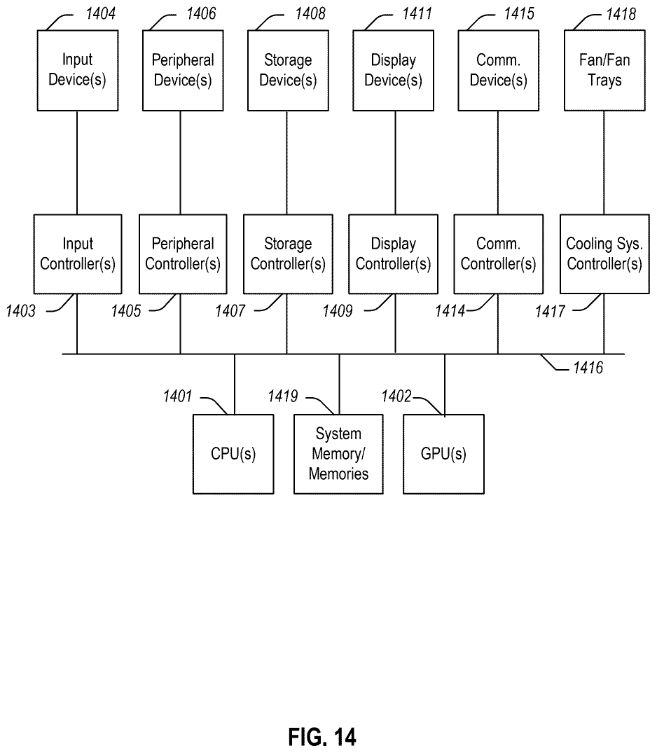

FIG. 14 depicts a simplified block diagram of a computing device/information handling system (or computing system) according to embodiments of the present disclosure. It will be understood that the functionalities shown for system 1400 may operate to support various embodiments of a computing system—although it shall be understood that a computing system may be differently configured and include different components, including having fewer or more components as depicted in FIG. 14.

As illustrated in FIG. 14, the computing system 1400 includes one or more central processing units (CPU) 1401 that provide computing resources and control the computer. CPU 1401 may be implemented with a microprocessor or the like and may also include one or more graphics processing units 919 and/or a floating-point coprocessor for mathematical computations. System 1400 may also include a system memory 1402.

A number of controllers and peripheral devices may also be provided, as shown in FIG. 14. An input controller 1403 represents an interface to various input device(s) 1404, such as a keyboard, mouse, touchscreen, and/or stylus. The computing system 1400 may also include a storage controller 1407 for interfacing with one or more storage devices 1408 each of which includes a storage medium such as flash memory or disk memory or RAM/ROM memory, or an optical medium that might be used to record programs of instructions for operating systems, utilities, and applications, which may include embodiments of programs that implement various aspects of the present invention. Storage device(s) 1408 may also be used to store processed data or data to be processed in accordance with the invention. The system 1400 may also include a display controller 1409 for providing an interface to a display device 1411, which may be a cathode ray tube, a thin film transistor display, organic light-emitting diode, electroluminescent panel, plasma panel, or other type of display. The computing system 1400 may also include one or more peripheral controllers or interfaces 1405 for one or more peripherals. Example of peripheral may include one or more printers, scanners, input devices, output devices, sensors, and the like. A communications controller 1414 may interface with one or more communication devices 1415, which enables the system 1400 to connect to remote devices through any of a variety of networks including the Internet, a cloud resource (e.g., an Ethernet cloud, a Fiber Channel over Ethernet/ Data Center Bridging cloud, etc.), a local area network, a wide area network, a storage area network, or through any suitable electromagnetic carrier signals including infrared signals. Cloud or wireless controller 1417 may also be provided that interface with various cloud or wireless devices 1418.

In the illustrated system, all major system components may connect to a bus, which may represent more than one physical bus. However, various system components may or may not be in physical proximity to one another. For example, input data and/or output data may be remotely transmitted from one physical location to another. In addition, programs that implement various aspects of the invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented as a whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize that no computing system or programming language is critical to the practice of the present invention. One skilled in the art will also recognize that a number of the elements described above may be physically and/or functionally separated into sub-modules or combined together.

It will be appreciated by those skilled in the art that the preceding examples and embodiments are exemplary and not limited to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method for moving and landing a solar table for a solar system, the method comprising:
transporting, by a mobile transport, the solar table toward a point of installation between a first pile and a second pile, the solar table comprises a torque tube and one or more solar modules attached to the torque tube;
scanning, using one or more stereo cameras or light detection and ranging (LIDAR) sensors within the mobile transport, ambient environment of the point of installation to obtain three-dimensional (3D) images;
determining a parking tolerance zone based on the 3D images, infrastructure information of the solar system, and parameters of the mobile transport;
parking the mobile transport within the parking tolerance zone; and
performing solar table landing to land the solar table.

2. The method of claim 1, wherein the infrastructure information of the solar system comprises one or more of:
information of installed piles; and
solar table parameters.

3. The method of claim 1, wherein the parameters of the mobile transport comprise one or more of:
weight of the mobile transport;
adjustment limits for horizonal, vertical, and side-shift movements; and
adjustment limits yaw/pitch/roll angle controls.

4. The method of claim 1, wherein the infrastructure information of the solar system and the parameters of the mobile transport are loaded to a memory integrated within the mobile transport for the mobile transport to determine the parking tolerance zone locally, or stored in a cloud or an edge device, the mobile transport the parking tolerance zone is determined at the cloud or the edge device and transmitted back to the mobile transport.

5. The method of claim 1, further comprising:
determining a viable path to the parking zone; and
providing feedback or guidance to an operator or an autonomous system of the mobile transport.

6. The method of claim 1, wherein solar table landing is performed autonomously using one or more positioning tags, the one or more positioning tags comprise a first positioning tag and a second positioning tag, both positioning tags are both visual fiducial markers;
wherein the first positioning tag is mounted on the first pile directly or on a first jig attached to a torque tube of a previously installed solar table securely supported onto the first pile, the torque tube of the previously installed solar table is a target torque tube for the torque tube of the solar table to connect; and
wherein the second positioning tag is mounted on the second pile directly or on a second jig installed on the second pile.

7. The method of claim 1, wherein performing solar table landing comprising:
performing a horizontal alignment for the solar table such that the torque tube of the landing solar table is longitudinally in parallel to the target torque tube;
performing a vertical alignment for the solar table to align the toque tube to a longitudinal axis of the target torque tube;
implementing an insertion process to insert one end of the torque tube into the target torque tube by a predetermined insertion distance; and
lowering the landing solar table onto the second jig attached to the second pile.

8. The method of claim 7, wherein the horizontal alignment is performed in a height above the first pile and the second pile for collision prevention.

9. The method of claim 7, wherein the landing solar table is positioned in a predetermined distance in front of the target torque tube when the horizontal alignment is completed.

10. The method of claim 7, wherein performing the horizontal alignment comprises activating one or more actuators for alignment involving one or more of:
side shift for the solar table;
yaw angle adjustment for the solar table;
roll angle adjustment for the solar table;
pitch angle adjustment for the solar table;
forward and/or backward movement for the solar table.

11. The method of claim 1, wherein performing autonomous solar table landing involves:
identifying a position of the first or the second pile with reference to the one or more
stereo cameras at a timestamp of each frame taken by the one or more stereo cameras;
calculating an alignment vector to align the torque tube of the solar table based on the identified position of the first or the second pile; and
calculating one or more target actuator positions with inverse kinematics.

12. The method of claim 1 further comprising:
sending from the mobile transport, the cloud, or the edge device an alert message to an on-site manager for attention and intervene in response to one or more of the following conditions:
the parking tolerance zone is unable to be determined;
a failure to complete a process autonomously; and
unable to move the mobile transport to the parking tolerance zone.

13. A mobile transport for moving and landing a solar table, the mobile transport comprising:
a transport component operable to move the solar table toward a point of installation between a first pile and a second pile, the solar table comprises a torque tube and one or more solar modules attached to the torque tube;
an attachment component coupled to the transport component, the attachment component comprising at least one attaching element that securely attaches to the solar table and a plurality of actuators for at least one alignment process implemented for autonomous solar table landing;
one or more stereo cameras or light detection and ranging (LIDAR) sensors to scan ambient environment of the point of installation to obtain three-dimensional (3D) images;
a controller coupled to transport component and the plurality of actuators, the controller determines a parking tolerance zone based on the 3D images, infrastructure information, and parameters of the mobile transport, and
wherein once the mobile transport is parked within the parking tolerance zone, the controller is configured to implement autonomous solar table landing to land the solar table.

14. The mobile transport of claim 13, wherein the infrastructure information of the solar system and the parameters of the mobile transport are loaded to a memory integrated within the mobile transport.

15. The mobile transport of claim 13, wherein the infrastructure information of the solar system comprises information of installed piles and solar table parameters and solar table parameters.

16. The mobile transport of claim 13, wherein he parameters of the mobile transport comprise one or more of:
weight of the mobile transport;
adjustment limits for horizonal, vertical, and side-shift movements; and
adjustment limits yaw/pitch/roll angle controls.

17. The mobile transport of claim 13, wherein autonomous solar table landing is performed using one or more positioning tags, the one or more positioning tags comprise a first positioning tag and a second positioning tag, both positioning tags are both visual fiducial markers,
wherein the first positioning tag is mounted on the first pile directly or on a first jig attached to a torque tube of a previously installed solar table securely supported onto the first pile, the torque tube of the previously installed solar table is a target torque tube for the torque tube of the solar table to connect; and
wherein the second positioning tag is mounted on the second pile directly or on a second jig installed on the second pile.

18. The mobile transport of claim 13, wherein the controller is configured to implement autonomous solar table landing by operations comprising:
performing a horizontal alignment for the solar table such that the torque tube of the landing solar table is longitudinally in parallel to the target torque tube;
performing a vertical alignment for the solar table to align the toque tube to a longitudinal axis of the target torque tube;
implementing an insertion process to insert one end of the torque tube into the target torque tube by a predetermined insertion distance; and
lowering the landing solar table onto the second jig attached to the second pile.

19. The mobile transport of claim 18, wherein the horizontal alignment is performed in a height above the first pile and the second pile for collision prevention.

20. The mobile transport of claim 13, wherein the controller is configured for:
identifying a position of the first or the second pile with reference to one or more stereo cameras at a timestamp of each frame taken by the one or more stereo cameras;
calculating an alignment vector to align the torque tube of the solar table based on the identified position of the first or the second pile; and
calculating one or more target actuator positions with inverse kinematics.
